(19) United States
(12) Patent Application Publication
(10) Pub. No.: US 2020/0079199 A1
(43) Pub. Date: Mar. 12, 2020

(54) SYSTEM AND METHODS FOR CHAMBERED PROTECTION COVERS

(71) Applicant: Kenneth Blueford, Mansfield, TX (US)

(72) Inventor: Kenneth Blueford, Mansfield, TX (US)

(21) Appl. No.: 16/127,132

(22) Filed: Sep. 10, 2018

(51) Int. Cl. B60J 11/04; E04H 15/02

(52) U.S. Cl. CPC B60J 11/04; B60R 2011/004; E04H 15/02

(57) ABSTRACT

Systems and methods are provided for protecting vehicles from damaging elemental forces using multi-chambered protection covers having one or more structural chambers are described. Protection systems of embodiments may include multi-chambered protection covers operable to provide a barrier against damaging elemental forces using a sleeve circumscribing an interior chamber with one or more structural chambers fixably disposed therein. Structural chambers of embodiments are configured to receive fluids operable to inflate the structural chambers into a rigid shape in advance of or in lieu of inflating the interior chamber. Accordingly, the sleeve and interior chamber may expand, by operation of the inflation of the structural chambers, to rapidly form a protective shell surrounding the vehicle. Additionally, one or more prefilled structural chambers may be configured to wholly or partially reducing deployment times associated with chamber inflation.

### TECHNICAL FIELD

The present invention relates to protection covers, and more particularly to a multi-chambered protection cover.

### BACKGROUND OF THE INVENTION

Elemental forces associated with severe storms (e.g., wind-borne debris, hail, corrosive precipitation, etc.) annually cause extensive property damage, bodily injury, and, in some situations, loss of life. The property damage can be as minimal as a few broken windows or as extreme as total destruction of vehicles and/or buildings. When elemental forces damage vehicles, vehicle owners may file insurance claims to pay for repairs, and insurers typically pay out billions of dollars in annual repair payments.

Some existing solutions for protecting vehicles from damaging elemental forces include a cover that is laid upon the vehicle. These existing covers may be manufactured from materials such as a fabric, plastics, and a variety of different materials. Some existing covers are made to follow the general contour and/or shape of a vehicle. However, these existing covers may not offer sufficient protection against elemental forces, as these covers may not be thick enough to prevent damage to the vehicle. Making these covers thick enough may require impracticably increasing the thickness of the cover such that it becomes too heavy and unwieldly and/or too expensive due to the amount of material used.

These existing covers also typically take considerable amounts of time to deploy. As a result, such covers require accurate weather prediction and advance deployment. However, weather prediction is not always accurate. For example, weather forecasting may predict whether thunderstorms have the characteristics conducive for forming hail but may not be able to accurately predict if and where hail may fall to the ground. This is because there is typically no clear distinction between storms that do and do not produce hailstones, and nearly all severe thunderstorms produce hail that may melt before reaching the ground. Furthermore, environmental factors that may contribute to wind-borne debris may be unknown to a driver operating a vehicle on the road. Thus, a vehicle owner may have little warning before encountering elemental forces that may pose a danger to his vehicle or person.

### BRIEF SUMMARY OF THE INVENTION

The present invention is directed to systems and methods which provide for vehicle protection against damaging elemental forces associated with severe storms (e.g., wind-borne debris, hail, corrosive precipitation, etc.) using a chambered protection cover. In some embodiments, at least one interior chamber within a protection cover of embodiments may be operable to provide damage protection with minimal use of material, and rapid deployment of the protection cover to shelter a vehicle (e.g., car, truck, van, boat, etc.).

In some embodiments, chambered protection covers of embodiments may include an outer sleeve (e.g., two flexible, non-permeable sheets fused along corresponding perimeter edges), at least one interior chamber (e.g., a space disposed within the outer sleeve), and at least one fluid port corresponding to the at least one interior chamber. In aspects, the chambered protection cover may include at least one structural chamber, and may include at least one fluid port corresponding to the at least one structural chamber. The fluid ports may be operable to allow passage of fluids (e.g., air, compressed air, CO₂, Nitrogen, etc.) into the chambers. In some embodiments, individual chambers within and without the multi-chambered protection cover may be configured to be filled with a fluid to provide an inflated chamber that protects the vehicle. Because the gas in the chambers multi-chambered protection cover is under pressure due to the inflation, the multi-chambered protection cover of embodiments provides superior protection over existing systems. In embodiments, the at least one structural chamber may be fixably disposed within a portion of the interior chamber and may be operable to define and maintain the outer sleeve of the chambered protection cover in a rigid shape.

In operation according to embodiments, chambered protection covers may be installed in a compressed state (e.g., the interior chamber and the one or more structural chambers are wholly or partially deflated) over the vehicle, whereby gases injected into the one or more structural chambers cause the one or more structural chambers to expand to an inflated state. Accordingly, the exterior sleeve and interior chamber may expand, by operation of inflation of the one or more structural chambers, to correspond to the inflated dimensions of the one or more structural chambers, thereby causing the multi-chambered protection cover to create a protective shell surrounding the vehicle. In aspects, the deployed shape of the multi-chambered protection cover may be configured to correspond to the contour and/or shape of the vehicle upon which the multi-chambered protection cover is deployed. In aspects, the multi-chambered protection cover may be individually customized to a specific vehicle, or may be manufactured to generally fit around a particular type of vehicle (e.g., mid-size sedan, large pickup, small SUV, etc.).

Multi-chambered protection covers of embodiments may be configured for rapid deployment over a vehicle. Accordingly, embodiments of the present invention may operate to protect the vehicle from damaging elemental forces by reducing the deployment time associated with existing systems and methods for protecting vehicles from damaging elemental forces. For example, the time period necessary to inflate the one or more structural chambers may be less than the time period necessary to inflate the interior chamber. By inflating the one or more structural chambers in advance of or in lieu of the interior chamber, the overall amount of time necessary to deploy the multi-chambered protection cover may be reduced, thereby facilitating rapid deployment of the multi-chambered protection covers. Additionally or alternatively, multi-chambered protection covers may be configured with one or more prefilled structural chambers operable to wholly or partially reduce deployment times associated with chamber inflation. Accordingly, protection covers of embodiments may be suitable for rapid deployment and protection of vehicles against damaging elemental forces associated with severe storms.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawings, in which:

FIGS. 1A-1C illustrate perspectives of a system configured in accordance with embodiments of the present invention;

FIGS. 2A-2B illustrate additional perspectives of a system configured in accordance with embodiments of the present invention; and

FIG. 3 illustrates a flow diagram for an operation in accordance with embodiments of the present invention.

### DETAILED DESCRIPTION OF THE INVENTION

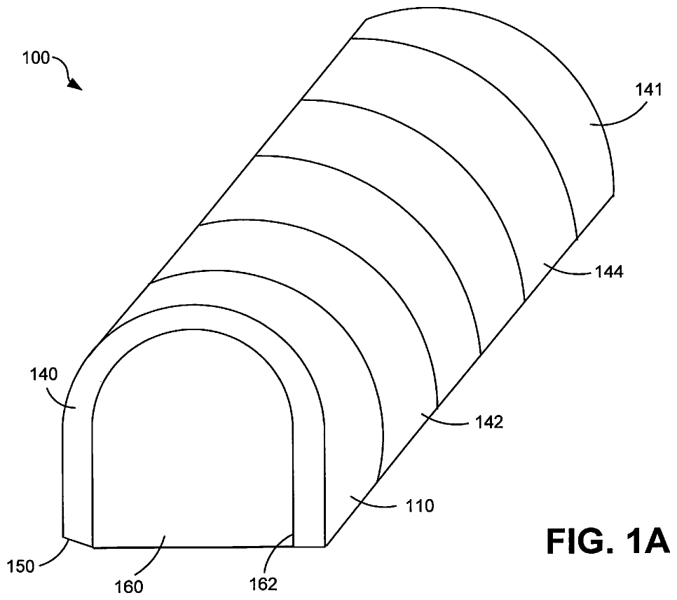

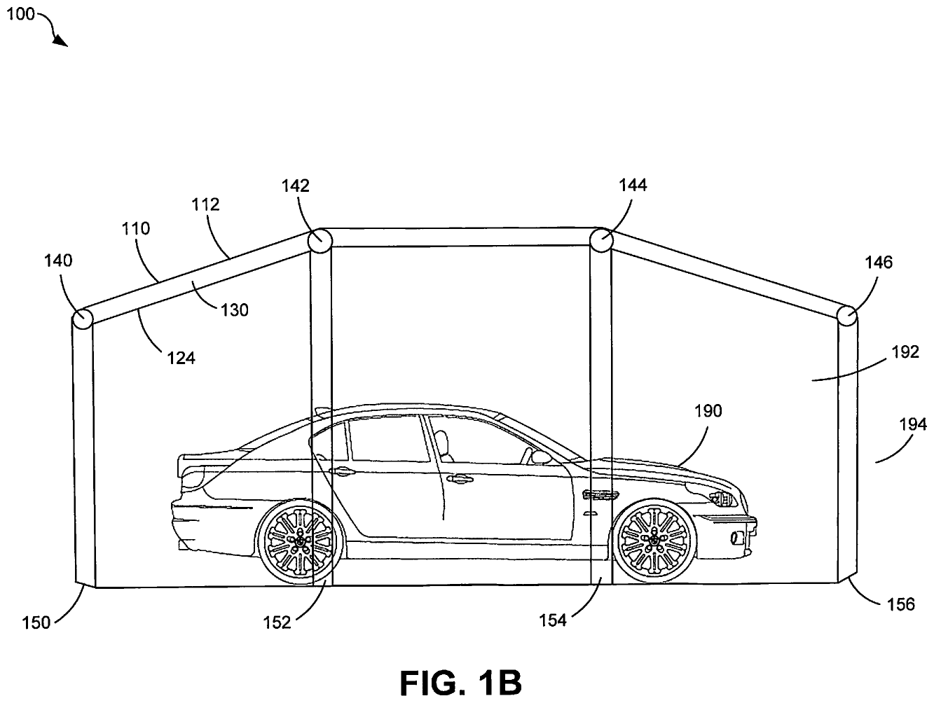

FIG. 1A shows a perspective view of a protection cover system in accordance with concepts of the present invention. Protection cover system 100 of the illustrated embodiment is configured to rapidly deploy over a vehicle to protect the vehicle from severe storms. In one embodiment, cover system 100 may comprise an inflatable chamber 170 configured to permit release and/or entry of fluids into and/or out of chamber 170. Fluids entering chamber 170 of cover system 100 may inflate chamber 170 such that chamber 170 may expand and take a deployment shape. In aspects, the deployment shape may conform to the shape of the vehicle upon which cover system 100 is deployed. The fluids within chamber 170 create a pressure that maintains chamber 170 inflated. As should be appreciated, the inflation of chamber 170 provides protection against objects striking cover system 100. In some aspects, the inflation of chamber 170 may be done by means of an external pump, or may be performed by a pump, such as pump 171, integrated within cover system 100.

Accordingly, protection cover system 100 shown in FIGS. 1A-1B includes multi-chambered protection cover 102 and vehicle 190. Multi-chambered protection cover 102 of protection cover system 100 includes sleeve 110, chamber 130, and structural chambers 140, 142, 144, and 146. Chamber 130 and structural chambers 140, 142, 144, and 146 may be disposed within sleeve 110 and may be utilized, in accordance with the concepts herein, to rapidly deploy multi-chambered protection cover 102 over vehicle 190 to protect vehicle 190 from damaging elemental forces (e.g., hail, wind-borne debris, corrosive precipitation, etc.). It is noted that vehicle 190 is depicted as a car for purposes of illustration, rather than by way of limitation, and, in other embodiments of protection cover system 100, vehicle 190 may include trucks, sport utility vehicles, vans, bikes, trailers, boats, or other vehicles

FIGS. 1B and 1C depict perspectives of embodiments of a protection cover system in accordance with concepts of the present invention. Protection cover system 100 of the illustrated embodiment is configured to rapidly deploy over a vehicle to protect the vehicle from severe storms. Accordingly, protection cover system 100 shown in FIGS. 1A-1B includes multi-chambered protection cover 102 and vehicle 190. Multi-chambered protection cover 102 of protection cover system 100 includes sleeve 110, chamber 130, and structural chambers 140, 142, 144, and 146. Chamber 130 and structural chambers 140, 142, 144, and 146 may be disposed within sleeve 110 and may be utilized, in accordance with the concepts herein, to rapidly deploy multi-chambered protection cover 102 over vehicle 190 to protect vehicle 190 from damaging elemental forces (e.g., hail, wind-borne debris, corrosive precipitation, etc.). It is noted that vehicle 190 is depicted as a car for purposes of illustration, rather than by way of limitation, and, in other embodiments of protection cover system 100, vehicle 190 may include trucks, sport utility vehicles, vans, bikes, trailers, boats, or other vehicles.

Sleeve 110 of embodiments may comprise first layer 112 and second layer 114 (e.g., non-permeable sheets of plastics, polymers, other materials suitable for operations described herein, or combinations thereof) suitable for circumscribing chamber 130. For example, first layer 112 and second layer 114 may be two sheets of flexible plastic fused at corresponding perimeter edges, and chamber 130 may be disposed within an interior area between first layer 112 and second layer 114. Preferably, first layer 112 and second layer 114 of embodiments may be configured (e.g., sized) to drape (e.g., extend or substantially extend) sleeve 110 over vehicle 190 in both a deflated and inflated state, as discussed below. According to embodiments, the size and shape of sleeve 110 may correspond to the dimensions of structural chambers 140, 142, 144, and 146. In operation according to embodiments, first layer 112 and second layer 114 may support the inflation of chamber 130 and structural chambers 140, 142, 144, and 146, as discussed below, and retain fluids (e.g., air, compressed air, other gases or liquids suitable for operations described herein, or combinations thereof) therein. Furthermore, sleeve 110 of embodiments may be operable to delineate interior space 192 underneath multi-chambered protection cover 102 and exterior space 194 outside of multi-chambered protection cover 102. For example, first layer 112 may be disposed towards exterior space 194 and second layer 114 may be disposed towards interior space 192.

In some embodiments, sleeve 110 may include valve 160 operable to permit release and/or entry of fluids into and/or out of chamber 130. For example, valves (e.g., one or more of valves 160) within first layer 112 may be configured to permit the natural flow of air into chamber 130 as structural chambers 140, 142, 144, and 146 inflate in accordance with operations described herein. In another example, after a severe storm has passed, valves (e.g., one or more of valves 160) within first layer 112 may be engaged to release air out of chamber 130 to facilitate storage (e.g., folding, compression, etc.) of multi-chambered protection cover 102. In additional embodiments, first layer 112 and second layer 114 may be configured with access port 162 suitable to provide access to interior space 192 and vehicle 190 disposed therein. For example, access port 162 may include one or more zipper assemblies, a plurality of buttons, any other mechanisms suitable for operations described herein, or combinations thereof, that may be opened or closed to provide a driver with access to vehicle 190 within interior space 192. In some embodiments, first layer 112 and/or second layer 114 may comprise corrosion-resistant material. It is noted that release valve 160 and access port 162 are each depicted as singular instances for purposes of illustration, rather than by way of limitation, and, in other embodiments of protection cover system 100, release valve 160 may include more than one valve configured to permit release and/or entry of fluids into and/or out of chamber 130 (e.g., one or more inlet ports, one or more outlet ports, one or more bidirectional ports, or combinations thereof) and access port 162 may include more than one passage through sleeve 110 operable to facilitate access to vehicle 190 within interior space 192.

Sleeve 110 of embodiments preferably include locking mechanisms (e.g., latches, hooks, magnets, clamps, or other devices suitable for operations herein) operable to secure sleeve 110 to vehicle 190. For example, a plurality of clamps may be dispose along perimeter edges of sleeve 110 and operable to engage with the undercarriage of vehicle 190 to prevent removal of multi-chambered protection cover 102 by damaging elemental forces (e.g., wind-borne debris, hail, corrosive precipitation, etc.) associated with a severe storm. In another example, a plurality of anchors may be dispose along perimeter edges of sleeve 110 and operable to engage with a subjacent ground surface (e.g., dirt, gravel, etc.) to prevent removal of multi-chambered protection cover 102 by elemental forces. Additionally or alternatively, weights (e.g., metal-filled chambers, polymer-filled chambers, foam-filed chambers, etc.) may be disposed along the perimeter edges of sleeve 110 to weigh down multi-chambered protection cover 102 and prevent removal of multi-chambered protection cover 102 by elemental forces.

Chamber 130 of embodiments may be an interior space of sleeve 110 configured (e.g., sized, shaped, etc.) to facilitate disposing of and inflation of structural chambers 140, 142, 144, and 146 therein, as discussed below. In operation according to embodiments, as structural chambers 140, 142, 144, and 146 inflate, as discussed below, the dimensions of chamber 130 may expand to correspond to the inflated dimensions of structural chambers 140, 142, 144, and 146. According to embodiments, the transverse dimensions of chamber 130 (e.g., space between first layer 112 and second layer 114 of sleeve 110) is preferably uniform across the longitudinal length of sleeve 110 and may correspond to the transverse dimensions of the inner perimeter of structural chambers 140, 142, 144, and 146 (e.g., dimensions of structural chambers 140, 142, 144, and 146 in deflated and inflated states).

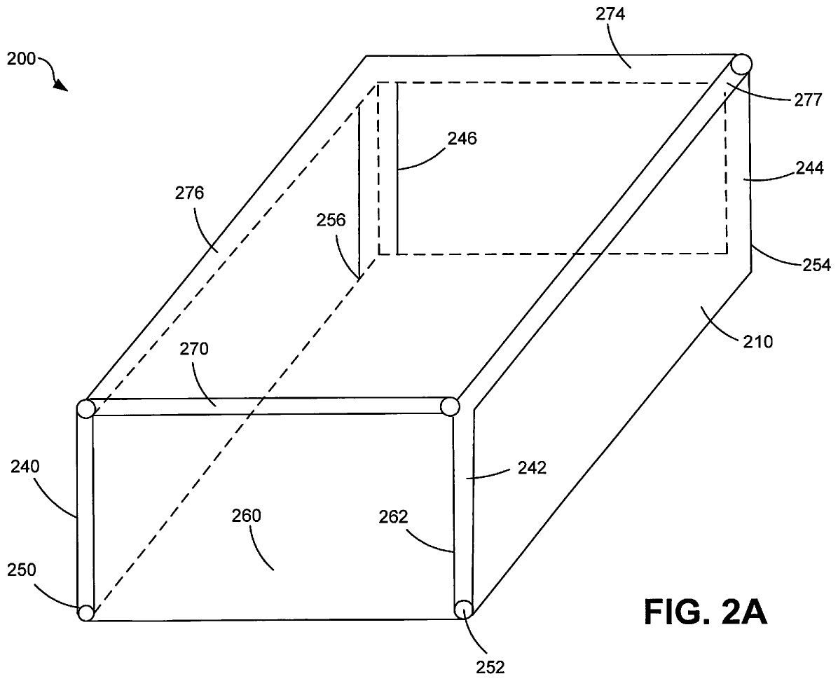

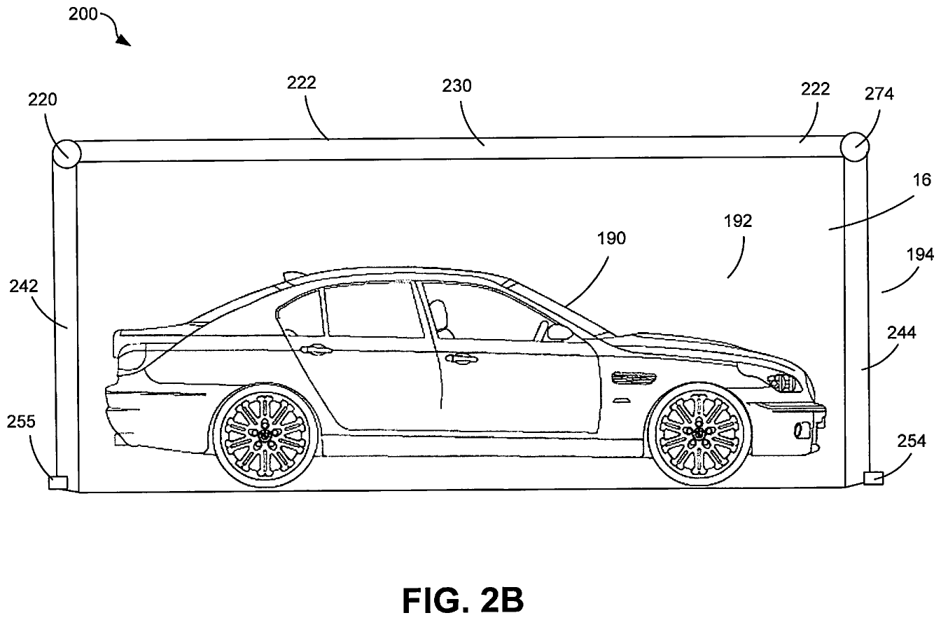

Structural chambers 140, 142, 144, and 146 of embodiments may comprise of flexible materials suitable for inflation and/or compression for storage, such as, for example, plastic, polymers, other materials suitable for operations described herein, or combinations thereof. According to embodiments, structural chambers 140, 142, 144, and 146 may be fixably disposed within chamber 130 of sleeve 110 and operable, when inflated, to define and maintain sleeve 110 of multi-chambered protection cover 102 in a rigid shape. For example, structural chambers 140, 142, 144, and 146 may be shaped as arches and secured (e.g., fused, clamped, etc.) to interior surfaces of first layer 112 and second layer 114 of sleeve 110 (e.g., surfaces facing chamber 130). As a result, structural chambers 140, 142, 144, and 146 may function, when inflated, as a skeletal frame for multi-chambered protection cover 102. Although depicted as arches framing multi-chambered protection cover 102 in FIGS. 1A-1B, in other embodiments of multi-chambered protection cover 102, structural chambers 140, 142, 144, and 146 may be configured as rectangular, semi-circular, or any other shapes suitable for operations described herein and/or wholly or partially along the perimeter edges of sleeve 110 (e.g., base of multi-chambered protection cover 102). In operation according to embodiments, structural chambers 140, 142, 144, and 146 may be inflated independent of or simultaneously with inflation of chamber 130. For example, the time period necessary to inflate structural chambers 140, 142, 144, and 146 may be less than the time period necessary to inflate chamber 130, and by inflating structural chambers 140, 142, 144, and 146 in advance of or in lieu of chamber 130, the overall amount of time necessary to deploy multi-chambered protection cover 102 may be reduced, thereby facilitating rapid deployment of multi-chambered protection cover 102 to protect vehicle 190 from damaging elemental forces. In some embodiments, structural chambers 140, 142, 144, and 146 may cooperate with prefilled structural chambers to further decrease deployment times, as discussed below with respect to FIGS. 2A-2B. It is noted that four structural chambers are depicted for purposes of illustration, rather than by way of limitation, and, in other embodiments of protection cover system 100, multi-chambered protection cover 102 may comprise more than four or less than four structural chambers. For example, a single structural chamber may include a portion extending along the longitudinal length of multi-chambered protection cover 102 to provide multi-chambered protection cover 102 with lateral stability and arched portions extending therefrom to provide multi-chambered protection cover 102 with vertical stability.

Preferably, structural chambers 140, 142, 144, and 146 include fluid ports 150, 152, 154, and 156 operable as a passage for fluids (e.g., air, compressed air, other gases or liquids suitable for operations described herein, or combinations thereof) to enter and/or exit structural chambers 140, 142, 144, and 146. According to embodiments, the configuration (e.g., size, shape, interface design, etc.) of fluid ports 150, 152, 154, and 156 may correspond to devices used to inflate structural chambers 140, 142, 144, and 146. For example, fluid ports 150, 152, 154, and 156 may include tire valves suitable for receiving air from an tire inflator device (e.g., bike pumps, portable air compressors, etc.) or disposable tire inflators (e.g., single-use cans devices providing pressurized gas, CO₂ cartridge inflator, Nitrogen cartridge inflators, etc.). It is noted that fluid ports 150, 152, 154, and 156 are depicted as singular passages corresponding to structural chambers 140, 142, 144, and 146 for purposes of illustration, rather than by way of limitation, and, in other embodiments of protection cover system 100, fluid ports 150, 152, 154, and 156 may each include more than one passage operable to allow fluids into and/or out of structural chambers 140, 142, 144, and 146 (e.g., one or more inlet ports, one or more outlet ports, one or more bidirectional ports, or combinations thereof). Additionally or alternatively, fluid ports 150, 152, 154, and 156 may correspond to a single structural chamber disposed within chamber 130, as discussed above. In some embodiments, structural chambers 140, 142, 144, and 146 may include interior release valves disposed within chamber 130 operable to permit flow of fluids from structural chambers 140, 142, 144, and 146 into chamber 130 to facilitate inflation of chamber 130. For example, as structural chambers 140, 142, 144, and 146 inflate to maximum capacity, excess fluids may flow into chamber 130 by way of the interior release valves of structural chambers 140, 142, 144, and 146 to facilitate inflation of chamber 130.

During operation of protection cover system 100, multi-chambered protection cover 102, in a deflated state, may be unfurled and draped over vehicle 190. Multi-chambered protection cover 102 is preferably protected against removal by damaging elemental forces of a severe storm by securing multi-chambered protection cover 102 to vehicle 190 and/or a ground surface subjacent to vehicle 190 using locking mechanisms and/or weights. Damaging elemental forces may include wind-borne debris, hail, corrosive precipitation, any other weathers that may damage vehicle 190, or combinations thereof.

After multi-chambered protection cover 102 has been draped over vehicle 190 and secured against elemental forces, one or more inflation devices (e.g., standalone inflator devices, disposable inflators, etc.) may utilized to inflate structural chambers 140, 142, 144, and 146. In some embodiments, inflation devices may be engaged with fluid ports 150, 152, 154, and 156 to inflate structural chambers 140, 142, 144, and 146. Additionally or alternatively, one or more structural chambers (e.g., select chambers of structural chambers 140, 142, 144, and 146) may be pre-equipped with disposable inflators (e.g., CO₂ cartridge inflators, Nitrogen cartridge inflators, etc.), whereby activation of the disposable inflators facilitates rapid inflation of structural chambers 140, 142, 144, and 146. In some embodiments, inflation devices may be engaged with valve 160 to inflate chamber 130 after or in parallel with the inflation of structural chambers 140, 142, 144, and 146. As structural chambers 140, 142, 144, and 146 inflate, the structural chambers form a skeletal frame for multi-chambered protection cover 102, thereby expanding multi-chambered protection cover 102 to an inflated state.

After multi-chambered protection cover 102 has expanded to an inflated state, sleeve 110 of multi-chambered protection cover 102 may function as a rigid, protective shell surrounding vehicle 190 that delineates interior space 192 underneath multi-chambered protection cover 102 and exterior space 194 outside of multi-chambered protection cover 102. As damaging elemental forces buffet against first layer 112, chamber 130 of multi-chambered protection cover 102 may absorb the impact of the damaging elemental forces. In some embodiments, multi-chambered protection cover 102 may also provide protection to persons. For example, a driver of vehicle 190 may be caught in a severe storm while traveling. In such a situation, the driver may rapidly deploy multi-chambered protection cover 102 to protect vehicle 190 against property damage and utilize access port 162 to gain entry to interior space 192 and/or vehicle 190 in order to protect against bodily injury. In additional or alternative embodiments, prefilled chambers, as discussed with respect to FIGS. 2A-2B, may be utilized to further reduce deployment times and allow for swift responses to abrupt weather developments. After the severe storm passes, multi-chambered protection cover 102 may be compressed to a deflated state by wholly or partially releasing fluids from structural chambers 140, 142, 144, and 146 and/or chamber 130. Once in the deflated state, multi-chambered protection cover 102 may be packed and stored, preferably within vehicle 190.

FIGS. 2A-2B depict additional perspectives of embodiments of a protection cover system in accordance with concepts of the present invention. Protection cover system 200 shown in FIGS. 2A-2B includes multi-chambered protection cover 202 and vehicle 190. Multi-chambered protection cover 202 of protection cover system 200 includes sleeve 210, chamber 230, prefilled chambers 270, 272, 274, and 276, and structural chambers 240, 242, 244, and 246. Protection cover system 200 shall be described herein with respect to differences to protection cover system 100 of FIGS. 1A-1B. Chamber 230, prefilled chambers 270, 272, 274, and 276, and structural chambers 240, 242, 244, and 246 may be disposed within sleeve 210 and may be utilized, in accordance with the concepts herein, to rapidly deploy multi-chambered protection cover 202 over vehicle 190 to protect vehicle 190 from damaging elemental forces.

Sleeve 210 of embodiments corresponds to sleeve 110 of FIGS. 1A-1B and may comprise first layer 212 and second layer 214, corresponding to first layer 112 and second layer 114 of FIGS. 1A-1B. In accordance with embodiments, sleeve 210 may circumscribe chamber 230, corresponding to chamber 130 of FIGS. 1A-1B. Chamber 230 of embodiments may be configured (e.g., sized, shaped, etc.) to facilitate disposing of prefilled chambers 270, 272, 274, and 276 and structural chambers 240, 242, 244, and 246 therein and inflation of structural chambers 240, 242, 244, and 246, as discussed below. Preferably, the dimensions of chamber 230 may expand to correspond to the dimensions of prefilled chambers 270, 272, 274, and 276 and inflated structural chambers 240, 242, 244, and 246. In some embodiments, sleeve 210 may include valve 260, access port 262, and/or locking mechanisms corresponding to valve 160, access port 162, and the locking mechanisms of FIGS. 1A-1B.

Structural chambers 240, 242, 244, and 246 of embodiments may be fixably disposed within chamber 230 of sleeve 210 and operable, when inflated and in cooperation with prefilled chambers 270, 272, 274, and 276, to define and maintain sleeve 210 of multi-chambered protection cover 202 in a rigid shape. Although depicted as vertical struts supporting prefilled chambers 270, 272, 274, and 276 in FIGS. 2A-2B, in other embodiments of multi-chambered protection cover 202, structural chambers 240, 242, 244, and 246 may be configured as upper arcs of framing arches, upper beams of rectangular frames, perimeter beams disposed wholly or partially along the perimeter edges of sleeve 210 (e.g., base of multi-chambered protection cover 202), any other configurations suitable for operations described herein, or combinations thereof. Structural chambers 240, 242, 244, and 246 of embodiments may include fluid ports 250, 252, 254, and 256 corresponding to fluid ports 150, 152, 154, and 156. In operation according to embodiments, the time period necessary to inflate structural chambers 240, 242, 244, and 246 is preferably be less than the time period necessary to inflate structural chambers 140, 142, 144, and 146 of FIGS. 1A-1B, thereby facilitating improved deployment of multi-chambered protection cover 202 to protect vehicle 190 from severe storms. In some embodiments, structural chambers 240, 242, 244, and 246 may include interior release valves disposed within chamber 230 operable to permit flow of fluids from structural chambers 240, 242, 244, and 246 into chamber 230 to facilitate inflation of chamber 230.

Prefilled chambers 270, 272, 274, and 276 of embodiments may be fixably disposed within chamber 230 of sleeve 210 and operable, in cooperation with structural chambers 240, 242, 244, and 246, to define and maintain sleeve 210 of multi-chambered protection cover 202 in a rigid shape. Accordingly to embodiments, prefilled chambers 270, 272, 274, and 276 may each comprise an exterior sleeve (e.g., plastics, polymers, other materials suitable for operations described herein, or combinations thereof) containing filler media (e.g., gases, liquids, foams, polymer beads and/or pellets, other materials suitable for operations described herein, or combinations thereof) therein and suitable for storage (e.g., compression, folded, rolled, etc.). Although depicted as horizontal struts atop structural chambers 240, 242, 244, and 246 in FIGS. 2A-2B, in other embodiments of multi-chambered protection cover 202, prefilled chambers 270, 272, 274, and 276 may be configured as vertical supporting struts, upper arcs of framing arches, perimeter beams disposed wholly or partially along the perimeter edges of sleeve 210 (e.g., base of multi-chambered protection cover 202), any other configurations suitable for operations described herein, or combinations thereof. In operation according to embodiments, fillable dimensions of structural chambers 240, 242, 244, and 246 may be reduced with respect to structural chambers 140, 142, 144, and 146 of FIGS. 1A-1B, thereby facilitating reduced inflation times and improved deployment speeds for multi-chambered protection cover 202.

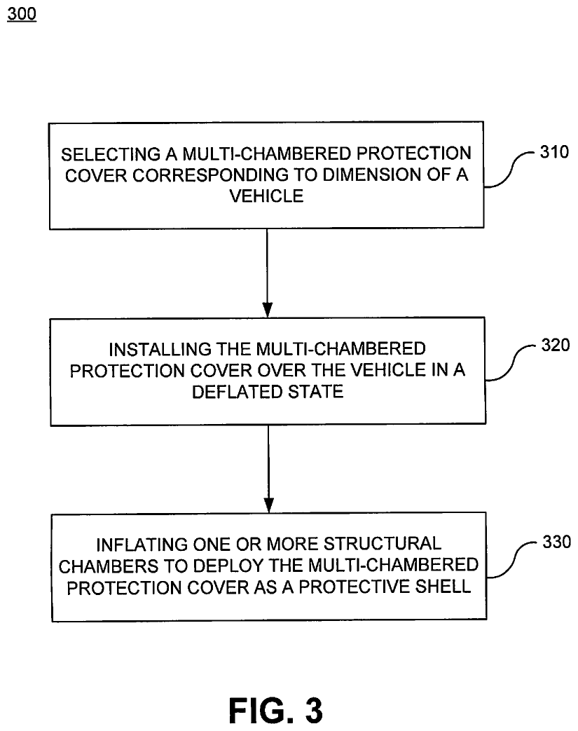

FIG. 3 illustrates example flow 300 for an operation of rapidly deploying a multi-chambered protection cover system over a vehicle according to embodiments of the invention to protect the vehicle from severe storms. Operations of flow 300 may, for example, be implemented with respect to components of multi-chambered protection cover 102 (e.g., sleeve 110, chamber 130, and structural chambers 140), shown in FIG. 1, for rapidly deploying over a vehicle to protect the vehicle from damaging elemental forces associated with severe storms. Accordingly, although operation in accordance with flow 300 is generally described below with reference to a single instance of a structural chamber (e.g., structural chamber 140), it should be appreciated that any number (e.g., two, three, four, etc.) of structural chambers (e.g., structural chambers 142, 144, and 146) may be utilized (e.g., simultaneously) in providing a rapidly deployable, multi-chambered protection cover system in accordance with operation of flow 300.

Flow 300 may begin at block 310, which includes selecting a multi-chambered protection cover to protect a vehicle from damaging elemental forces. The dimensions of multi-chambered protection cover (e.g., multi-chambered protection cover 102 of FIGS. 1A-1B) is preferably sufficient to extend over the dimensions of the vehicle (e.g., vehicle 190 of FIGS. 1A-1B) with ample slack to facilitate expansion of the multi-chambered protection cover to an inflated state over the vehicle. In the inflated state, the multi-chambered protection cover preferably circumscribes an interior space (e.g., interior space 192 of FIGS. 1A-1B) that affords a buffer space between the vehicle and an interior surface of the multi-chambered protection cover (e.g., second layer 114 of FIGS. 1A-1B).

Once appropriate dimensions have been selected for the expendable fluid drive actuator, at block 320 illustrated in FIG. 3, flow 300 may further include installing the multi-chambered protection cover in a deflated state over the vehicle. The multi-chambered protection cover may be draped over the vehicle and secured against removal by damaging elemental forces. In some embodiments, the multi-chambered protection cover may be secured to the vehicle using locking mechanisms (e.g., latches, hooks, magnets, clamps, or other devices suitable for operations herein). For example, a plurality of clamps along the perimeter edges the multi-chambered protection cover may be engaged to the undercarriage of the vehicle. In another example, anchors may be used to secure the multi-chambered protection cover to a subjacent ground surface (e.g., dirt, gravel, etc.). Additionally or alternatively, weighted portions along the perimeter edges the multi-chambered protection cover may be used to weigh the multi-chambered protection cover down against the subjacent ground surface.

Once the multi-chambered protection cover has been installed over the vehicle, at block 330, flow 300 may further include inflating the multi-chambered protection cover to an inflated state. Inflation devices (e.g., standalone inflator devices, disposable inflators, etc.) may be engaged with one or more fluid ports (e.g., fluid ports 150, 152, 154, and 156 of FIGS. 1A-1B) to inflate the structural chamber (e.g., structural chamber 140). Additionally or alternatively, the structural chamber may be pre-equipped with disposable inflators (e.g., CO₂ cartridge inflators, Nitrogen cartridge inflators, etc.), whereby activation of the disposable inflators facilitate rapid inflation of the structural chamber. The inflating structural chamber, alone or in conjunction with other structural chambers, functions as a frame along which components of the multi-chambered protection cover (e.g., sleeve 110, chamber 130 of FIGS. 1A-1B) may expand. By inflating the structural chamber instead of the interior chamber that extends along the entire dimensions of the multi-chambered protection cover (e.g., chamber 130 of FIGS. 1A-1B), the overall time period to inflate the multi-chambered protection cover may be reduced, thereby facilitating rapid deployment of the multi-chambered protection cover to an inflated state.

After the multi-chambered protection cover has expanded to the inflated state, the sleeve of the multi-chambered protection cover functions as a rigid, protective shell surrounding the vehicle and delineating an interior space (e.g., interior space 192 of FIGS. 1A-1B) underneath the multi-chambered protection cover and an exterior space (e.g., exterior space 194 of FIGS. 1A-1B) outside of the multi-chambered protection cover. As damaging elemental forces buffet against a first layer of the multi-chambered protection cover (e.g., first layer 112 of FIGS. 1A-1B), the interior chamber of the multi-chambered protection cover may absorb the impact of the elemental forces. In some embodiments, the multi-chambered protection cover may also provide protection to persons. For example, a driver of vehicle may be caught in a severe storm while traveling, and the driver may rapidly deploy the multi-chambered protection cover to protect the vehicle against property damage and utilize an access port (e.g., access port 162 of FIGS. 1A-1B) to gain entry to the interior space and/or the vehicle to protect against bodily injury. In additional or alternative embodiments, prefilled chambers, as discussed above, may be utilized to further reduce deployment times and allow for swift responses to abrupt weather developments. In some embodiments, the inflation devices may be engaged with valves associated with the interior chamber of the multi-chambered protection cover to inflate the interior chamber after or in parallel with the inflation of the structural chamber.

Although the embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed:

1. A protective cover to protect a vehicle from elemental forces, said protective cover having a deployed configuration, said protective cover comprising:
an inflatable sleeve including a first layer of a first material, a second layer of a second material, and at least one inflatable structural chamber;
means for securing the protective cover to the vehicle against removal by the elemental forces;
means for causing a fluid to flow into the at least one inflatable structural chamber to transition the protective cover to the deployed configuration, wherein transitioning the protective cover to the deployed configuration includes:
receiving the fluid into the at least one inflatable structural chamber; and
inflating the at least one inflatable structural chamber to a rigid frame in response to the receiving the fluid, wherein the first layer and the second layer are configured to separate from one another in response to the at least one inflatable structural chamber inflating to a rigid frame, wherein the first layer is disposed to contact the vehicle when in the deployed configuration, and the second layer is disposed to engage the elemental forces when in the deployed configuration, wherein the separation between the first layer and the second layer provides an air gap acting as a barrier against the elemental forces, and wherein the inflated inflatable sleeve delineates a shape of the vehicle in the deployed configuration.

2. The method of claim 1, wherein the means for securing the protective cover against removal by the elemental forces comprise means for engaging a plurality of locking mechanisms to the vehicle.

3. The method of claim 1, wherein means for securing the protective cover against removal by the elemental forces comprise means for engaging a plurality of locking mechanisms to a ground surface subjacent to the vehicle.

4. The method of claim 1, wherein the means for causing the fluid to flow into the at least one inflatable structural chamber comprises at least one fluid port operable to inject the fluids into the least one inflatable structural chamber.

5. The method of claim 1, wherein the first material includes a material configured to prevent damage to the vehicle.

6. The method of claim 1, wherein the at least one inflatable structural chamber includes a plurality of structural chambers, wherein the plurality of structural chambers is configured to deploy as the rigid frame, the rigid frame defining the delineated shape.

7. The method of claim 7, wherein at least one of the plurality of structural chambers is prefilled with the fluid.

8. The method of claim 1, wherein the inflatable sleeve comprises at least one access port operable to facilitate passage of a user from the exterior space to the interior space.

9. The method of claim 8, wherein the access port is operable by engaging and disengaging at least one of: one or more zipper assemblies, and a subset of a plurality of buttons.

10. An apparatus for protecting a vehicle from elemental forces, comprising:
a sleeve circumscribing a chamber, wherein the chamber is disposed between a first layer and a second layer of the sleeve, wherein the first layer of the sleeve delineates an exterior space and the second layer of the sleeve delineates an interior space, wherein the vehicle is disposed within the interior space, and wherein the elemental forces are engaged against the first layer; and
one or more inflatable structural chambers disposed within the chamber, wherein each of the one or more inflatable structural chambers is inflated to a rigid frame that defines dimensions of the chamber and the sleeve, wherein the sleeve surrounding the rigid frame of the one or more inflatable structural chambers is operable as a barrier against the elemental forces.

11. The apparatus of claim 10, further comprising at least one fluid port coupled to each of the one or more inflatable structural chambers, wherein the at least one fluid port of each of the one or more inflatable structural chambers is configured to receive fluids into the corresponding one or more inflatable structural chambers, wherein the received fluids cause the one or more inflatable structural chambers to inflate.

12. The apparatus of claim 10, further comprising a plurality of locking mechanisms coupled to the sleeve and operable to secure the sleeve against removal by the elemental forces.

13. The apparatus of claim 10, further comprising one or more prefilled structural chambers operable to cooperate with the one or more inflatable structural chambers to form the rigid frame.

14. The apparatus of claim 10, wherein the sleeve comprises at least one access port operable to facilitate passage of a user from the exterior space to the interior space.

15. The apparatus of claim 14, wherein the access port is operable by engaging and disengaging one or more zipper assemblies.

16. The apparatus of claim 14, wherein the access port is operable by engaging and disengaging a subset of a plurality of buttons.

17. A system for rapid deployment of a protective cover for a vehicle, comprising:
a chamber circumscribed by a sleeve comprising a first layer and a second layer, wherein the first layer of the sleeve delineates an exterior space and the second layer of the sleeve delineates an interior space, wherein the vehicle is disposed within the interior space, and wherein elemental forces are engaged against the first layer;
one or more prefilled structural chambers disposed within the chamber, wherein each of the one or more prefilled structural chambers is operable as a first rigid frame; and
one or more inflatable structural chambers disposed within the chamber, wherein each of the one or more inflatable structural chambers is operable to receive fluids and configured to inflate to a second rigid frame, wherein the second rigid frame and the first rigid frame cooperate to define dimensions of the chamber and the sleeve, wherein the sleeve surrounding the first rigid frame and the second rigid frame is operable as a barrier against the elemental forces.

18. The system of claim 17, further comprising at least one fluid port coupled to each of the one or more inflatable structural chambers, wherein the at least one fluid port of each of the one or more inflatable structural chambers is configured to receive fluids into the corresponding one or more inflatable structural chambers, wherein the received fluids cause the one or more inflatable structural chambers to inflate.

19. The system of claim 17, further comprising a plurality of locking mechanisms coupled to the sleeve and operable to secure the sleeve against removal by the elemental forces.

20. The system of claim 17, wherein the sleeve comprises corrosion-resistant material.
